(19) United States
(12) Patent Application Publication
(10) Pub. No.: US 2023/0139423 A1
(43) Pub. Date: May 4, 2023

(54) HUMIDITY CONTROLLING MATERIAL AND HUMIDITY CONTROLLING APPARATUS

(71) Applicant: SHARP KABUSHIKI KAISHA, Sakai City, Osaka (JP)

(72) Inventors: Yuusuke SHIMIZU, Sakai City, Osaka (JP); TSUYOSHI KAMADA, Sakai City, Osaka (JP); TETSUYA IDE, Sakai City, Osaka (JP); KYOKO MATSUURA, Sakai City, Osaka (JP); SHO OCHI, Sakai City, Osaka (JP)

(21) Appl. No.: 17/912,034

(22) PCT Filed: Mar. 3, 2021
(86) PCT No.: PCT/JP2021/008130

§ 371 Date: Sep. 15, 2022

(30) Foreign Application Priority Data
Mar. 31, 2020 (JP) 2020-061765

(51) Int. Cl. B01D 53/26; B01D 53/18; B01D 53/28; G01N 21/81

(52) U.S. Cl. CPC B01D 53/263; B01D 53/18; B01D 53/28; G01N 21/81; B01D 2257/80; B01D 2252/50

(57) ABSTRACT

A humidity controlling material includes: a first particle; and a second particle. The first particle includes: a first humidity controlling liquid containing a hygroscopic substance; and a first holding portion holding the first humidity controlling liquid. The second particle includes: a second humidity controlling liquid containing the hygroscopic substance; and a second holding portion holding the second humidity controlling liquid. The first holding portion and the second holding portion are formed of a polymeric material. The first humidity controlling liquid includes a first indicator a color of which changes according to an amount of moisture contained in the first humidity controlling liquid. The second humidity controlling liquid includes a second indicator a color of which changes, in a transition range different from a transition range of the first indicator, according to an amount of moisture contained in the second humidity controlling liquid.

### TECHNICAL FIELD

The present invention relates to a humidity controlling material and a humidity controlling apparatus. The present application claims priority to Japanese Patent Application No. 2020-061765, filed on Mar. 31, 2020, the contents of which are incorporated herein by reference in its entirety.

### BACKGROUND ART

Conventionally, hygroscopic materials made of polymeric materials and formed into beads are known (see, for example, Patent Document 1). A hygroscopic material (hygroscopic millimeter-beads) described in Patent Document 1 is characterized by high hygroscopicity and small dimensional change upon absorbing and releasing moisture.

### CITATION LIST

### Patent Literature

Patent Document 1: Japanese Unexamined Patent Application Publication No. 2017-056404

### SUMMARY OF INVENTION

### Technical Problems

However, because of the above characteristic, it is difficult for a user who uses the above hygroscopic material to understand how much moisture the hygroscopic material has absorbed by the appearance of the hygroscopic material in use. Hence, for example, a problem of the hygroscopic material is that it is difficult for the user to understand when to replace the hygroscopic material.

In addition, regardless of the hygroscopic material described above, if the user could understand how much moisture has been absorbed by the moisture-absorbing material in use, the hygroscopic material would be easy to use. That is why improvement has been required of the hygroscopic material.

In view of the above circumstances, an aspect of the present invention is intended to provide a humidity controlling material with which the amount of absorbed moisture is easily understood. Another aspect of the present invention is intended to provide a humidity controlling apparatus including the above humidity controlling material with which the amount of absorbed moisture is easily understood.

### Solution to Problems

In order to solve the above problems, an embodiment of the present invention includes the aspects below.

[1] A humidity controlling material comprising: a first particle capable of absorbing or discharging moisture in air; and a second particle capable of absorbing or discharging moisture in the air, wherein the first particle includes: a first humidity controlling liquid containing a hygroscopic substance; and a first holding portion holding the first humidity controlling liquid, the second particle includes: a second humidity controlling liquid containing the hygroscopic substance; and a second holding portion holding the second humidity controlling liquid, the first holding portion and the second holding portion are formed of a polymeric material, the first humidity controlling liquid includes a first indicator a color of Which changes according to an amount of moisture contained in the first humidity controlling liquid, and the second humidity controlling liquid includes a second indicator a color of which changes, in a transition range different from a transition range of the first indicator, according to an amount of moisture contained in the second humidity controlling liquid.

[2] The humidity controlling material according to [1], wherein at least one of the first humidity controlling liquid or the second humidity controlling liquid contains two or more kinds of the hydroscopic substances.

[3] The humidity controlling material according to [2], wherein the hydroscopic substance contains a hygroscopic polyalcohol and a hygroscopic inorganic salt.

[4] The humidity controlling material according to any one of [1] to [3], wherein the polymeric material forming the first holding portion and the second holding portion is a water-absorbing polymer.

[5] The humidity controlling material according to any one of [1] to [3], wherein the first particle has a core-shell structure including: a core containing the first humidity controlling liquid;

and the first holding portion formed of the polymeric material and shaped into a shell, and the second particle has a core-shell structure including: a core containing the second humidity controlling liquid; and the second holding portion formed of the polymeric material and shaped into a shell.

[6] The humidity controlling material according to any one of [1] to [3], wherein the first particle has a core-shell structure including: a core containing the first humidity controlling liquid; and the first holding portion formed of the polymeric material and shaped into a shell, and the second holding portion included in the second particle is a water-absorbing polymer.

[7] The humidity controlling material according to any one of [1] to [6, further comprising a fixed color particle configured to indicate a certain color.

[8] The humidity controlling material according to [7], wherein the fixed color particle includes: a humidity controlling liquid containing the hygroscopic substance; and a holding portion holding the humidity controlling liquid in a form of a particle.

[9] A humidity controlling apparatus, comprising: the humidity controlling material according to any one of [1] to [8]; and a housing portion housing the humidity controlling material, wherein the housing portion is at least partially transparent to light.

[10] The humidity controlling material according to [9], wherein the housing portion includes: a first housing portion housing the first particle; and a second housing portion housing the second particle.

[11] The humidity controlling material according to claim 10, further comprising a removing portion configured to remove moisture contained in the humidity controlling material.

[12] The humidity controlling material according to [11], wherein the first particle has a core-shell structure including: a core containing the first humidity controlling liquid; and the first holding portion formed of the polymeric material and shaped into a shell, the second holding portion included in the second particle is a water-absorbing polymer, and the removing portion is disposed closer to the first housing portion than to the second housing portion.

### Advantageous Effects of Invention

An aspect of the present invention can provide a humidity controlling material with which the amount of absorbed moisture can be easily understood. An aspect of the present invention can provide a hygroscopic material with which the amount of absorbed moisture can be easily understood. Moreover, an aspect of the present invention can provide a humidity controlling apparatus including the above humidity controlling material so that the amount of absorbed moisture is easily understood.

### BRIEF DESCRIPTION OF DRAWINGS

FIG. 1 is a schematic view of a humidity controlling material 1 according to a first embodiment.

FIG. 2 is a schematic view of a first particle 1A or a second particle 1B according to the first embodiment.

FIG. 3 is a schematic view of a humidity controlling material 2 according to a second embodiment.

FIG. 4 is an illustration of a humidity controlling material 3 according to a third embodiment.

FIG. 5 is an illustration of a humidity controlling apparatus 100 according to a fourth embodiment.

FIG. 6 is an illustration of a humidity controlling apparatus 200 according to a fifth embodiment.

### DESCRIPTION OF EMBODIMENTS

### First Embodiment

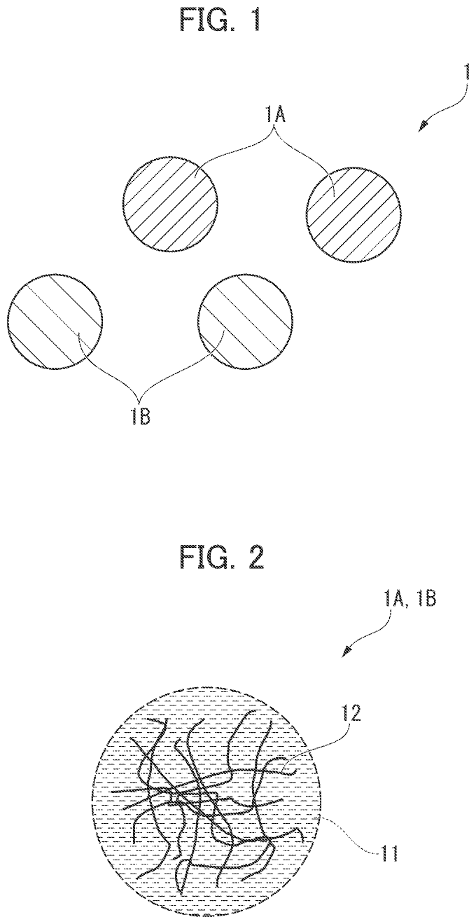

FIGS. 1 and 2 are illustrations of a humidity controlling material 1 according to this embodiment. Note that, in all the drawings below, the constituent features vary in dimensions and proportions as appropriate so that the drawings are easy to see.

FIG. 1 is a schematic view of the humidity controlling material 1 according to this embodiment. The humidity controlling material 1 according to this embodiment includes: first particles 1A capable of absorbing or discharging moisture in the air; and second particles 1B capable of absorbing or discharging moisture in the air. The humidity controlling material 1 according to this embodiment absorbs or releases moisture contained in the air in which the humidity controlling material 1 is placed, depending on the humidity of an environment in which the humidity controlling material 1 placed.

The humidity controlling material 1 will be described below in sequence.

### <First Particle and Second Particle>

FIG. 2 is a schematic view of a first particle 1A or a second particle 1E according to this embodiment. Each of the first particle 1A and the second particle 1B includes: a humidity controlling liquid 11; and a holding portion 12 holding the humidity controlling liquid 11.

In this DESCRIPTION, the term “humidity control” means to adjust the amount of water vapor contained in the air. The humidity control includes both “moisture absorption” that involves removing water vapor in the air to relatively reduce the amount of the water vapor contained in the air, and “humidification” that involves supplying water vapor to the air to relatively increase the amount of the water vapor contained in the air.

In the description below, the humidity controlling liquid included in the first particle 1A may be referred to as a “first humidity controlling liquid”, and the holding portion included in the first particle 1A may be referred to as a “first holding portion”.

Likewise, the humidity controlling liquid included in the second particle 1B may be referred to as a “second humidity controlling liquid”, and the holding portion included in the second particle 1B may be referred to as a “second holding portion”.

Moreover, if the first humidity controlling liquid and the second humidity controlling liquid are described without di stint ti on, the term “humidity controlling liquid” is used in common.

Likewise, if the first holding portion and the second holding portion are described without distinction, the term “holding portion” is used in common.

### <Humidity Controlling Liquid>

The humidity controlling liquid 11 included in the first particle 1A and the second particle 1B has a property of absorbing moisture contained in the surrounding air (hygroscopicity) until the humidity controlling liquid 11 reaches an equilibrium with the humidity of the air in which the first particle 1A and the second particle 1B are placed, if the air in which the first particle 1A and the second particle 1B are placed is relatively wet compared with the humidity controlling liquid 11.

In addition, the humidity controlling liquid 11 has a property of releasing in the air moisture contained in the humidity controlling liquid 11 until the humidity controlling liquid 11 reaches an equilibrium with the humidity of the air in which the first particle 1A and the second particle 1B are placed, if the air in which the first particle and the second particle 1B are placed is relatively dry compared with the humidity controlling liquid.

Note that, when also heated, the humidity controlling liquid 11 releases in the air moisture contained in the humidity controlling liquid 11.

The humidity controlling liquid 11 contains: a hygroscopic substance; and an indicator a color of which changes according to the amount of moisture contained in the humidity controlling liquid 11.

### (Hygroscopic Substance)

The hygroscopic substance can include an organic material and an inorganic material.

Examples of the hygroscopic organic material to be used as the hygroscopic substance include divalent or more than divalent alcohols (polyalcohols), ketones, organic solvents having amide groups, saccharides, and known materials to be used as raw materials of moisturizing cosmetics. Among these materials, the organic materials to be preferably used as the hygroscopic substance include polyalcohols, organic solvents having amid groups, saccharides, and known materials to be used as raw materials of moisturizing cosmetics. Such organic materials are high in hydrophilicity.

Examples of the polyalcohols include glycerin, propanediol, butanediol, pentanediol, trimethylolpropane, butanetriol, ethylene glycol, diethylene glycol, and tri ethylene glycol. Moreover, the hygroscopic polyalcohols may be dimers or polymers of the polyalcohols.

Examples of the organic solvents having amid groups include formamide and acetamide.

Examples of the saccharides include sucrose, pullulan, glucose, xylol, fructose, mannitol, and sorbitol.

Examples of the known materials to be used as raw materials of moisturizing cosmetics include 2-methacryloyloxyethyl phosphorylcholine (MPC), betaine, hyaluronic acid, and collagen.

Examples of the hygroscopic inorganic material to be used as the hygroscopic substance include hygroscopic inorganic salts. These inorganic salts include:

chlorides such as calcium chloride, lithium chloride, magnesium chloride, potassium chloride, sodium chloride, zinc chloride, aluminum chloride, strontium chloride, and barium chloride;

bromides such as lithium bromide, calcium bromide, and potassium bromide;

nitrates such as magnesium nitrate, calcium nitrate, strontium nitrate, and barium nitrate;

and

metal salts such as magnesium sulfate, sodium hydroxide, and sodium pyrrolidone carboxylic acid.

Among the inorganic salts, lithium chloride and calcium chloride are preferable.

In addition, the hygroscopic inorganic materials include phosphorus oxide, silica gel, alunite, and zeolite.

Silica gel, alunite, and zeolite are dispersed in a dispersing medium to form a dispersion liquid. The dispersion liquid can constitute the humidity controlling liquid 11. As the dispersion medium, a polar solvent can be used. Examples of the polar solvent includes water, ethanol, methanol, glycerin, diglycerin, polyglycerin, and ethylene glycol.

The humidity controlling liquid 11 preferably contains two or more kinds of hygroscopic substances. When the humidity controlling liquid 11 contains two or more kinds of hygroscopic substances, physical properties of the humidity controlling liquid 11 are easily adjusted.

If the hygroscopic substance contains two or more kinds of hygroscopic substances, for example, two or more kinds of polyalcohols may be used, two or more kinds of inorganic salts may be used, or a polyalcohol and an inorganic salt may be used in combination.

The humidity controlling liquid 11 preferably contains a hygroscopic polyalcohol and a hygroscopic inorganic salt.

### (Indicator)

As the indicator included in the humidity controlling liquid 11 according to this embodiment, a pH indicator can be preferably used. The humidity controlling liquid 11 changes in pH as concentration of the humidity controlling liquid 11 changes. That is, the humidity controlling liquid 11 changes in pH in accordance with the amount of absorbed moisture. Hence, when the humidity controlling liquid 11 includes the pH indicator, the first particle 1A and the second particle 1B change in color in accordance with the amount of moisture absorbed by the humidity controlling liquid 11.

Moreover, the humidity controlling material 1 (the first particle 1A and the second particle 1B) according to this embodiment absorbs or releases moisture until the humidity controlling material 1 reaches an equilibrium with the humidity of the air in which the humidity controlling material 1 is placed. Hence, when a correspondence relationship is examined in advance between a color of the pH indicator and the humidity of the environment in which the first particle 1A and the second particle 1B are placed, the humidity of the environment in which the humidity controlling material 1 is placed can be understood in a simple manner by the colors of the first particle 1A and the second particle 1B.

In the descriptions below, an indicator included in the first particle 1A may be referred to as a “first indicator”, and an indicator included in the second particle 1B may be referred to as a “second indicator”.

Examples of the pH indicator includes known pH indicators such as methyl yellow, bromophenol blue, conga red, methyl orange, bromocresol green, methyl red, litmus, bromocresol purple, bromothymol blue, phenol red, thymol blue, neutral red, cresol red litmus, paranitrophenol, methyl purple, and phenolphthalein.

Moreover, as the pH indicator, triarylmethane derivatives, fluoran derivatives, pyrazolone derivatives, azo derivatives, and xanthene derivatives can also be used.

Each of the first indicator and the second indicator to be used may be of one kind alone. Alternatively, two or more kinds of the first indicators and the second indicators may be used in combination.

If two or more kinds of pH indicators are mixed and used, a compound ratio for use of the pH indicators can be a known mixing ratio. For example, as an indicator included in the humidity controlling liquid 11 of this embodiment, among the above pH indicators, a Yamada-type universal indicator (a universal pH indicator) containing thymol blue, methyl red, bromothymol blue, and phenolphthalein may be used.

In the humidity controlling material 1 of this embodiment, the first index and the second index have different transition ranges. Hence, the first particle 1A and the second particle 1B can be different from each other in a correspondence relationship between the colors of the indicators and the humidity of the environment in which the humidity control ling material 1 is placed.

Usually, when exhibiting color reaction, a pH indicator exhibits a color change with a slight change in pH. Meanwhile, the pH indicator exhibits a dull color change in a range other than the transition range. Hence, when the humidity controlling material 1 has only one kind of indicator, there is one transition range, and it is difficult to detect a change in concentration of the humidity controlling liquid in a pH range other than the transition range (concentration of the humidity controlling liquid).

In contrast, as seen in the humidity controlling material 1 of this embodiment, if the first indicator of the first particle 1A and the second indicator of the second particle 1B have different transition ranges, it is possible to establish a relationship in which the color change of one of the indicators is sharp in a pH range while the color change of the other indicator is dull in the pH range. Hence, it is easy to detect the concentration change of the humidity controlling liquid, and to understand the humidity of the environment in which the humidity controlling material 1 is placed.

It is preferable that the colors of the first indicator and the second indicator are different from each other. It is also preferable that the colors of the first index and the second index have a pH range in which the colors of the first index and the second index are different from each other in an angle of 30 degrees or more on the color circle in color change depending on pH. With the humidity controlling material 1 using such a first index and a second index, it is easy to check the color change.

A combination of the first indicator and the second indicator can be, for example, bromocresol green as the first indicator and a universal pH indicator as the second indicator.

### (Other Substances)

Moreover, the humidity control ling liquid 11 may contain a solvent as another substance. The solvent includes a solvent in which the above hygroscopic substance dissolves, or a solvent with which the hygroscopic substance is mixed. An example of such a solvent can include water.

Furthermore, as the solvent, the polyalcohol or the organic solvent mentioned above as the hygroscopic organic material may be used.

When the humidity controlling liquid 11 contains the solvent, a mixing ratio (a mass ratio) of the solvent to the indicator is preferably in a range of (solvent): (indicator)=100:1 to 50:1.

In addition, the humidity controlling liquid 11 may contain a dye for color adjustment as another substance.

### <Holding Portion>

The holding portion 12 included in the first particle 1A and the second particle 1B has a function of holding the humidity controlling liquid 11 described above.

The holding portion 12 of this embodiment is formed of a known water-absorbing polymeric material (a water-absorbing polymer). Examples of the material for forming the holding portion 12 include polyacrylate, starch-acrylate graft polymer, vinyl acetate copolymer, maleic anhydride copolymer, and polyvinyl alcohol.

### <Method for Manufacturing Humidity Controlling Material>

A method fix manufacturing the humidity controlling material 1 according to this embodiment can include a step of manufacturing the holding portion 12 and a step of swelling the humidity controlling liquid 11 with the obtained holding portion 12.

In the step of manufacturing the holding portion 12, the holding portion 12 can be manufactured by a known inversed phase suspension polymerization technique. Specifically, the holding portion 12 can be manufactured of: a continuous phase such as a hydrophobic organic solvent containing a surfactant and a dispersant; and a disperse phase such as a liquid mixture containing a monomer including a repeating unit of the water-absorbing polymeric material described above, a polymerization initiator, and a crosslinking agent. The continuous phase and the liquid mixture are subjected to suspension polymerization to form the holding portion 12.

Examples of the monomer can include acrylic acid, vinyl acetate, vinyl alcohol, and maleic anhydride.

Examples of the polymerization initiator can include an organic peroxide and an azo compound, each known as a radical polymerization initiator.

The crosslinking agent is used to adjust the water absorption performance of the holding portion 12 to be obtained. The larger the amount of the crosslinking agent to be copolymerized with the monomer is, the denser the crosslinking of the polymeric material included in the holding portion 12 is, thereby decreasing the hygroscopicity. The smaller the amount of the crosslinking agent to be copolymerized with the monomer is, the coarser the crosslinking of the polymeric material included in the holding portion 12 is, thereby increasing the hygroscopicity.

Examples of the organic solvent as the continuous phase can include aliphatic hydrocarbons, alicyclic hydrocarbons, aromatic hydrocarbons, aliphatic alcohols, aliphatic ketones, and aliphatic esters.

The surfactant that can be used shall not be limited to a particular surfactant, and any of an anionic surfactant, a cationic surfactant, an amphoteric surfactant, and a nonionic surfactant can be used.

The dispersant shall not be limited to a particular dispersant as long as the dispersant can stably disperse the monomer in the organic solvent. The dispersant may be a known dispersant. Examples of the dispersant can include fatty acid ester, cellulose ether, and cellulose ester.

The holding portion 12 manufactured by the inversed phase suspension polymerization technique is preferably dried.

Note that, in the polymerization, silica (colloidal crystals) arranged regularly may be added to the holding portion 12. After the polymerization, the silica is etched and removed so that the holding portion 12 may be colored with a structural color. The holding portion 12 having the structural color can be manufactured in the same manner as a known technique of manufacturing an inverse opal gel.

Before immersed in the humidity controlling liquid 11, the holding portion 12 may have a size (a diameter) of, for example, 1 mm or more and 30 mm or less. The size of the holding portion 12 can be controlled by changing at least one selected from the group consisting of the agitation speed, the amount of the surfactant, the amount of the dispersant, and the amount of the polymerization initiator in the above-mentioned inversed phase suspension polymerization.

Moreover, the first particle 1A and the second particle 1B obtained by immersing the holding portion 12 in the humidity controlling liquid 11 become larger than the holding portion 12 before being immersed in the humidity controlling liquid 11, because the humidity controlling liquid 11 swells. For example, the first particle 1A and the second particle 1B can have a size (a diameter) of 4 mm or more and 150 mm or less.

The first particle 1A and the second particle 1B included in the humidity controlling material 1 absorb moisture from the surrounding air when the air in which the humidity controlling material 1 is placed is relatively wet compared with the humidity controlling liquid 11. Moreover, the first particle 1A and the second particle 1B release the absorbed moisture when the air in which the humidity controlling material 1 is placed is relatively dry compared with the humidity controlling liquid 11.

When the amount of the held moisture changes in this manner, the humidity controlling liquid 11 included in the first particle 1A and the second particle 1B changes in concentration, and in pH. As a result, the indicator included in the humidity controlling liquid 11 exhibits color reaction, making it possible to detect that the first particle 1A and the second particle 1B have absorbed, or released, moisture.

The first particle 1A and the second particle 1B respectively include the first indicator and the second indicator having different transition ranges. Hence, the first particle 1A and the second particle 1B easily detect the concentration change of the humidity controlling liquid, and the humidity of the environment in which the humidity controlling material 1 is placed.

Moreover, the first particle 1A and the second particle 1B swell by absorbing moisture, and become larger in diameter than the first particle 1A and the second particle 1B before absorbing the moisture. In addition, the first particle 1A and the second particle 1B contract by releasing moisture, and become smaller in diameter than the first particle 1A and the second particle TB before releasing the moisture. Hence, the humidity controlling material 1 can detect that the humidity controlling material 1 has absorbed or released moisture, in accordance with the sizes of the first particle 1A and the second particle 1B. Furthermore, the humidity controlling material 1 can easily detect the humidity in which the humidity controlling material 1 is placed, in accordance with the sizes of the first particle 1A and the second particle 1B.

A ratio of the first particles 1A to the second particles 1B that constitute the humidity controlling material 1 may be set appropriately, in view of the colors of the first indicator and the second indicator to be used and of how easily the first particles 1A and the second particles 1B can be checked for the color change. For example, a mass ratio of the first particles 1A to the second particles 1B may be set as follows: (the first particles): (the second particles) may be 10:90 to 90:10, 25:75 to 75:25, or 40:60 to 60:40.

The humidity controlling material 1 of the above-described configuration can be provided as a moisture absorbing material with which the amount of absorbed moisture can be easily understood.

### Second Embodiment

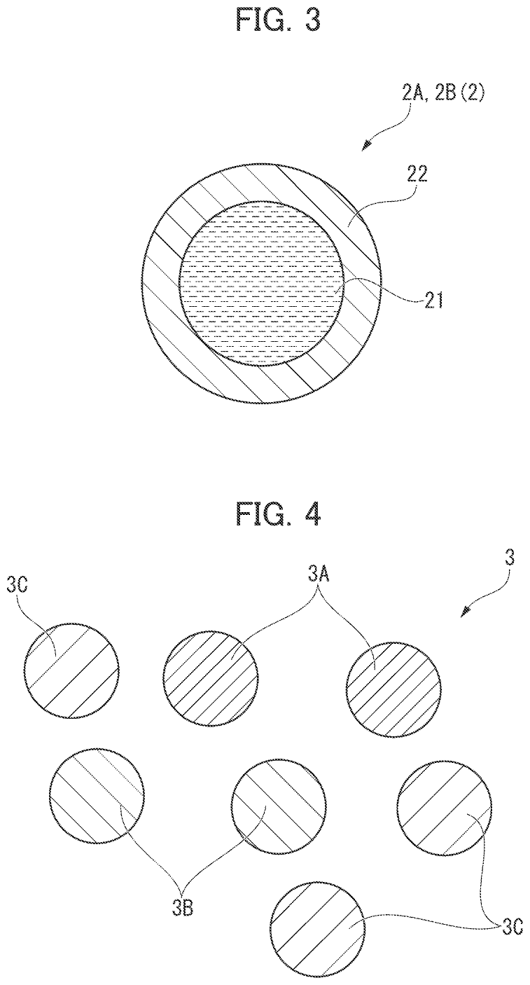

FIG. 3 is an illustration of a humidity controlling material 2 according to a second embodiment. FIG. 3 is an illustration of a first particle 2A or a second particle 2B included in the humidity controlling material 2.

Each of the first particle 2A and the second particle 2B included in the humidity controlling material 2 according to this embodiment includes: a humidity controlling liquid 21; and a holding portion 22 holding the humidity controlling liquid 21. The humidity controlling material 2 according to this embodiment absorbs or releases moisture contained in the air in which the humidity controlling material 2 is placed, in accordance with the humidity of an environment in which the humidity controlling material 2 is placed.

The first particle 2A included in the humidity controlling material 2 of this embodiment has a core-shell structure including: a core containing the humidity controlling liquid 21; and a first holding portion formed of a polymeric material and shaped into a shell.

The second particle 2B included in the humidity controlling material 2 of this embodiment has a core-shell structure including: a core containing the humidity controlling liquid 21; and a second holding portion formed of a polymeric material and shaped into a shell.

### <Humidity Controlling Liquid>

The humidity controlling liquid 21 contains: a hygroscopic substance; an indicator a color of which changes according to the amount of moisture contained in the humidity controlling liquid 21; and a material to form the holding portion 22.

As the hygroscopic substance and the indicator, each of the substances exemplified in the first embodiment can be used.

The material for forming the holding portion 22 contained in the humidity controlling liquid 21 will be described later.

### <Holding Portion>

The holding portion 22 corresponds to the shell (the first holding portion) of the first particle 2A, or the shell (the second holding portion) of the second particle 2B, The first particle 2A and the second particle 2B have a core-shell structure. The holding portion 22 is a hollow particle having a space to hold therein the humidity controlling liquid 21.

The holding portion 22 can be formed of a polymeric material that reacts with a gelling agent to form a gel. Specifically, as the material for forming the holding portion 22, monovalent alginate, polysaccharides such as carboxymethyl cellulose and methyl cellulose, and polyalcohols such as polyvinyl alcohol can be used.

In this DESCRIPTION, the above materials to be used as the materials for forming the holding portion 22 are not included in the “water-absorbing polymer”; that is, a material for forming the holding portion 12.

The gelling agent, which reacts with the above polymeric material so that the polymeric material forms a gel, includes a polyvalent metal salt aqueous solution, an acidic aqueous solution, and a sodium tetraborate aqueous solution.

The polyvalent metal salt includes polyvalent metal ion salts such as calcium salts, magnesium salts, barium salts, and aluminum salts.

Combinations of the gel-forming polymeric material and the gelling agent include the following:

(1) a combination of monovalent alginate and a polyvalent metal salt solution;
(2) a combination of monovalent alginate and an acidic aqueous solution;
(3) a combination of (carboxy) methyl cellulose and a polyvalent metal salt solution; and
(4) a combination of polyvinyl alcohol and a sodium tetraborate aqueous solution.

Note that the “(carboxy) methyl cellulose” means both methyl cellulose and carboxymethyl cellulose.

The holding portion 22 may contain the above humidity controlling liquid.

The holding portion 22 is permeable to moisture.

### <Method for Manufacturing Humidity Controlling Material>

A method for manufacturing the first particle 2A and the second particle 2B includes a step of preparing a humidity controlling liquid, a step of obtaining a liquid mixture in which a material for forming the holding portion is mixed with the humidity controlling liquid, and a step of dripping the liquid mixture into a gelling agent.

The step of preparing the humidity controlling liquid involves mixing together the hygroscopic substance, the indicator, the solvent, and another substance, all of which are described above.

The step of obtaining the liquid mixture involves mixing an aqueous solution, which is separately prepared to contain a material for forming the holding portion, with the humidity controlling liquid. For example, in the case where sodium alginate is used as the material for forming the holding portion, a sodium alginate aqueous solution of, in mass percent, 1% or more and 5% or less is prepared and mixed with the humidity controlling liquid.

A proportion of the humidity controlling liquid to the Whole liquid mixture can be, in mass percent, 10% or more and 90% or less.

The step of dripping the liquid mixture into the gelling agent involves dripping the obtained liquid mixture into a galling agent aqueous solution. In the case where sodium alginate is used as the material for forming the holding portion, for example, a calcium chloride aqueous solution is used as the gelling agent. A concentration of the calcium chloride aqueous solution can be, in mass percent, 1% or more and 10% or less, for example.

When the liquid mixture is dripped into the gelling agent, the sodium alginate contained in the surface of a droplet of the dripped liquid mixture reacts with the gelling agent to form a gel. As a result, the gelled surface of the droplet becomes the shell (the holding portion 22) of the humidity controlling material 2; and the non-gelled interior of the droplet becomes the core of the first particle 2A or the second particle 2B.

After dripping the liquid mixture into the gelling agent, the particles to be obtained may be removed from the gelling agent within 24 hours. This feature can reduce a problem of which the gelling agent penetrates into the center of the first particle 2A and the second particle 2B such that the particles are entirely gelled. The time period for removing the first particle 2A and the second particle 2B may be changed in accordance with the composition and the size of the particles after a preliminary experiment is conducted in advance and a time period during Which no problem occurs is checked.

Moreover, the method may include a step of freeze-drying the particles obtained at the step of dripping the liquid mixture into the gelling agent. The freeze-drying involves freezing the above particles, and, after that, sublimating frozen moisture in a reduced pressure environment. Hence, the moisture in the holding portion is partially removed, and the portions from which the moisture is removed are deemed pores. As a result, the particles after the freeze-drying are deemed wider in surface area than the particles before the freeze-drying, and the Obtained particles (the humidity controlling material 2) are deemed more likely to absorb moisture than the particles before the freeze-drying.

Furthermore, the freeze-drying can also be expected to have an advantageous effect of cutting off a portion of the polymeric material included in the holding portion 22 to reduce the molecular weight of the polymeric material. Hence, the cross-linking of the polymeric material included in the holding portion 22 becomes coarse, thereby increasing the hygroscopicity.

The humidity controlling material 2 of the above-described configuration can also be provided as a humidity controlling material with which the amount of absorbed moisture or the amount of released moisture is easily understood.

Note that, in this embodiment, both the first particle 2A and the second particle 2B have a core-shell structure; however, the first particle 2A and the second particle 2B shall not be limited to have such a structure. The first particle 2A may have the core-shell structure described in the second embodiment, and the second particle 2B may have the same structure as the structure of the second particle 1B described in the first embodiment.

In the description below, the particles described in the first embodiment are referred to as “swollen particles”. Moreover, the particles described in the second embodiment are referred to as “core-shell particles”.

A ratio of the swollen particles to the core-shell particles included in the humidity controlling material may be set appropriately. For example, a mass ratio of the swollen particles to the core-shell particles may be set as follows: (the swollen particles): (the core-shell particles) may be 10:90 to 90:10, 25:75 to 75:25, or 40:60 to 60:40.

### Third Embodiment

FIG. 4 is an illustration of a humidity controlling material 3 according to a third embodiment of the present invention. The humidity controlling material 3 according to this embodiment includes: first particles 3A; second particles 3B; and fixed color particles 3C.

As a first particle 3A, either the first particle 1A of the first embodiment or the first particle 2A of the second embodiment can be employed.

As a second particle 3B, either the second particle 1B of the first embodiment or the second particle 2B of the second embodiment can be employed.

A fixed color particle 3C is a particle that indicates a certain color, regardless of the amount of moisture absorbed by the humidity controlling material 3. The fixed color particle 3C may or may not have a function of absorbing or releasing the moisture contained in the air in which the humidity controlling material 3 is placed, depending on the humidity of an environment in which the humidity controlling material 3 is placed.

In the description below, the function of “absorbing or releasing the moisture contained in the air in which the humidity controlling material 3 is placed” may be referred to as a “humidity control function”.

If the fixed color particle 3C does not have the humidity control function, glass or a polymeric material can be used as a material for forming the fixed color particle 3C.

If the fixed color particle 3C has the humidity control function, the fixed color particle 3C includes: a humidity controlling liquid containing a hygroscopic substance; and a holding portion holding the humidity controlling liquid in the form of a particle.

As the humidity controlling liquid included in the fixed color particle 3C, the humidity controlling liquid described above can be employed.

As the holding portion included in the fixed color particle 3C, the holding portion described above can be employed.

That is, the fixed color particle 3C may be a particle obtained by removing the indicator from the first particle 1A of the first embodiment, or a particle obtained by removing the indicator from the first particle 2A of the second embodiment.

A color of the fixed color particle 3C may be the same as, or different from, a color of the first particle or the second particle.

Moreover, if there is a target of the humidity to be adjusted using the humidity controlling material 3, the color of the fixed color particle 3C is the same as the color of the first particle or the second particle at the target humidity. If the fixed color particle 3C has such a color, it is easy to determine whether the environment in which the humidity controlling material is placed has reached the target humidity.

Because the humidity controlling material 3 contains the filed color particle 3C, the color change of the first particle 3A and the second particle 3B can be easily recognized.

A ratio of the first particles 3A to the second particles 3B to the fixed color particles 3C that constitute the humidity controlling material 3 may be set appropriately, in view of the colors of the first indicator and the second indicator to be used, of the color of the fixed color particles 3C, and of how easily the first particles 3A and the second particles 3B can be checked for the color change. For example, a mass ratio of a sum of the first particles 3A and the second particles 3B to the fixed color particles 3C may be set as follows: (the first particles+the second particles): (the fixed color particles)=10:90 to 90:10, 25:75 to 75:25, or 40:60 to 60:40.

A ratio of the first particles 3A to the second particles 3B can be appropriately set as described in the first embodiment.

The humidity controlling material 3 of the above configuration can also be provided as a hygroscopic material with which the amount of absorbed moisture is easily understood.

### Fourth Embodiment

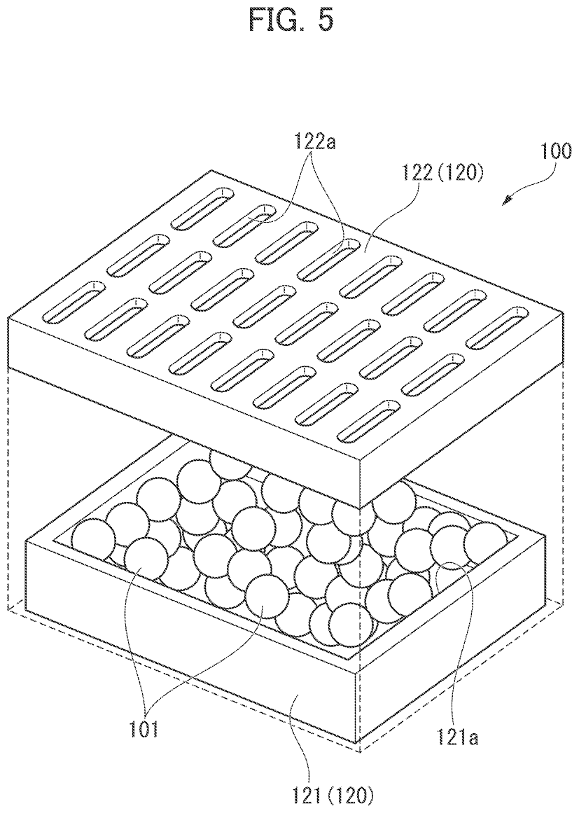

FIG. 5 is an illustration of a humidity controlling apparatus 100 according to a fourth embodiment of the present invention. The humidity controlling apparatus 100 includes: a humidity controlling material 110; and a housing portion 120. The housing portion 120 includes: a container 121; and a lid 122.

As the humidity controlling material 110, any of the humidity controlling materials 1 to 3 described above can be employed. The humidity controlling material 110 is filled in the container 121.

The container 121 includes an internal space for filling the humidity controlling material 110, and an upper portion of the container 121 is open to have an opening portion 121a. The container 121 illustrated in FIG. 5 is a flat thin container having a rectangular shape in plan view and a height direction dimension smaller than a plane direction dimension.

The container 121 is preferably transparent to light so that a state of the humidity controlling material 110 can be visually recognized. As a material for forming the container 121, a light-transparent material can be preferably used. For example, as the material for forming the container 121, a known polymeric material such as glass, polystyrene, polyolefin, polyethylene terephthalate (PET), polymethyl methacrylate (PMMA), or polyvinyl chloride (PVC) can be used.

The container 121 may be totally, or only partially, transparent to light.

The lid 122 covers the container 121 from above the container 121 to close the opening portion 121a. As a result, the housing portion 120 houses the humidity controlling material 110 inside the housing portion 120.

The lid 122 includes a plurality of through holes 112a penetrating the lid 112 in the thickness direction. Through the through holes 122a, the air in which the humidity controlling apparatus 100 is placed flows into, and out of, the housing portion 120.

A size of the through holes 122a can be set appropriately as long as the humidity controlling material 110 cannot pass through the through holes 122a, and as long as the air flow is not obstructed. Moreover, the shape of the through holes 122a in plan view can also be set appropriately as long as the function of the through holes 122a is not obstructed.

The lid 122 may or may not be transparent to light.

As a material for forming the lid 122, a polymeric material can be preferably used.

The above humidity controlling apparatus 100 includes the humidity controlling material described above. With the humidity controlling apparatus 100, it is easy to understand the amount of absorbed moisture.

### Fifth Embodiment

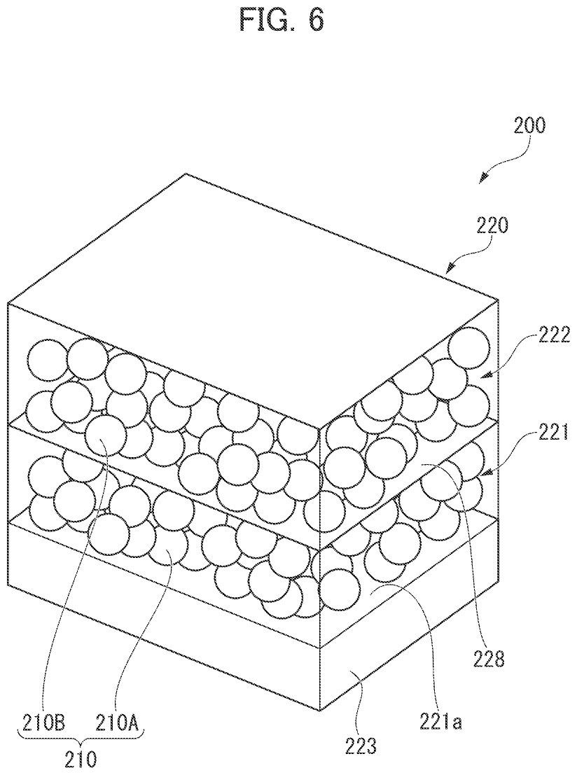

FIG. 6 is an illustration of a humidity controlling apparatus 200 according to a fifth embodiment of the present invention. The humidity controlling apparatus 200 includes: a humidity controlling material 210; and a housing portion 220.

As the humidity controlling material 210, any of the humidity controlling materials 1 to 3 described above can be employed.

The housing portion 220 includes: a first housing portion 221; a second housing portion 222; and a removing portion 223.

The first housing portion 221 is a space housing first particles 210A included in the humidity controlling material 210.

The second housing portion 222 is a space housing second particles 210B included in the humidity control ling material 210.

The first housing portion 221 and the second housing portion 222 each include: an inlet for taking in external air into the first housing portion 221 and the second housing portion 222; and an outlet for discharging air of the first housing portion 221 and the second housing portion 222 to the outside. The inlet and the outlet may be provided in any given position as long as the advantageous effects of the humidity controlling apparatus 200 are not obstructed.

Moreover, a plurality of through holes may be provided to wall surfaces of the first housing portion 221 and the second housing portion 222, and the through holes may function inlets and outlets. The through holes may be in the form of a mash or slits.

The first housing portion 221 and the second housing portion 222 are adjacent to each other through a partition 228 including a through hole through which air can flow. In the humidity controlling apparatus 200, the first housing portion 221 and the second housing portion 222 are arranged in the height direction (a vertical direction) across the partition 228.

A wall of the first housing portion 221 and a wall of the second housing portion 222 are at least partially transparent to light.

As a material for forming the first housing portion 221 and the second housing portion 222, the material for forming the container 121 in the fourth embodiment described above can be employed.

The removing portion 223 removes moisture from the humidity controlling material 210. The removing portion 223 is located below the first housing portion 221. That is, the removing portion 223 is disposed closer to the first housing portion 221 than to the second housing portion 222.

The removing portion 223 includes an air blower that blows air to the first housing portion 221 and the second housing portion 222. The removing portion 223 can blow air to the first housing portion 221 and the second housing portion 222, and partially remove moisture from the first particles 210A housed in the first housing portion 221 and the second particles 210B housed in the second housing portion 222.

Moreover, the removing portion 223 may include a heat source. The removing portion 223 including the heat source sends warm air or hot air to the first housing portion 221 and the second housing portion 222 to heat the first particles 210A and the second particles 210B. As a result, moisture partially evaporates from the first particles 210A and the second particles 2106.

Moreover, the removing portion 223 may include a light source that irradiates the first particles 210A and the second particles 210B with light. When the first particles 210A and the second particles 210B are irradiated with light, the first particles 210A and the second particles 210B absorb the light and generate heat. Because of the generated heat, moisture partially evaporates from the first particles 210A and the second particles 210B.

When the removing portion 223 includes the light source, a bottom portion 221a of the first housing portion 221 may be transparent to light.

Furthermore, when the removing portion 223 includes the light source, the first housing portion 221 and the second housing portion 222 may each have a stirring device that stirs the first particles 210A and the second particles 210B. As a result, the humidity controlling material 210 (the first particles 210A or the second particles 210B) changes in position in each housing portion, and the entire humidity controlling material 210 is more likely to be irradiated with light.

In addition, when the removing portion 223 includes the light source, black fixed color particles may be mixed in either one of, or both, the first housing portion 221 and the second housing portion 222. The black fixed color particles suitably absorb light and generate heat, thereby making it possible to accelerate evaporation of a portion of moisture from the first particles 210A and the second particles 210B.

In the configuration described above, the first particles 210A housed in the first housing portion 221 near the removing portion 223 are preferably particles having a core-shell structure similar to the first particles 2A described in the second embodiment.

Moreover, the second particles 210B housed in the second accommodating portion 222 far from the removing portion 223 are preferably particles in which the humidity controlling liquid 11 is swollen with the holding portion 12, similar to the first particles 1A described in the first embodiment.

The core-shell particles are relatively less likely to dry than the swollen particles. Hence, the core-shell particles are disposed in a position near the removing portion 223, so that moisture can be suitably removed from the core-shell particles.

Moreover, the humidity controlling apparatus 200 may include a fan that allows air to flow inside the humidity controlling apparatus 200. The fan, for example, takes air into the humidity controlling apparatus 200 from the outside of the humidity controlling apparatus 200, and allows the air to flow inside the humidity controlling apparatus 200. As a result, the air around the humidity controlling material 210 included in the humidity controlling apparatus 200 is easily replaced, and humidity control is easily carried out.

The above humidity controlling apparatus 200 includes the humidity controlling material described above. With the humidity controlling apparatus 200, it is easy to understand the amount of absorbed moisture.

Although preferred embodiments according to the present invention have been described above with reference to the accompanying drawings, it is needless to say that the present invention is not limited to such embodiments. Various shapes and combinations of the constituent members shown in the examples described above are merely examples, and can be modified in various manners in accordance with design requirements unless otherwise departing from the subject matter of the present invention.

1. A humidity controlling material, comprising:
a first particle capable of absorbing or discharging moisture in air; and
a second particle capable of absorbing or discharging moisture in the air,
wherein the first particle includes: a first humidity controlling liquid containing a hygroscopic substance; and
a first holding portion holding the first humidity controlling liquid,
the second particle includes: a second humidity controlling liquid containing the hygroscopic substance; and
a second holding portion holding the second humidity controlling liquid,
the first holding portion and the second holding portion are formed of a polymeric material,
the first humidity controlling liquid includes a first indicator a color of which changes according to an amount of moisture contained in the first humidity controlling liquid, and
the second humidity controlling liquid includes a second indicator a color of which changes, in a transition range different from a transition range of the first indicator, according to an amount of moisture contained in the second humidity controlling liquid.

2. The humidity controlling material according to claim 1,
wherein at least one of the first humidity controlling liquid or the second humidity controlling liquid contains two or more kinds of the hydroscopic substances.

3. The humidity controlling material according to claim 2,
wherein the hydroscopic substance contains a hygroscopic polyalcohol and a hygroscopic inorganic salt.

4. The humidity controlling material according to claim 1,
wherein the polymeric material forming the first holding portion and the second holding portion is a water-absorbing polymer.

5. The humidity controlling material according to claim 1,
wherein the first particle has a core-shell structure including: a core containing the first humidity controlling liquid; and
the first holding portion formed of the polymeric material and shaped into a shell, and
the second particle has a core-shell structure including: a core containing the second humidity controlling liquid; and
the second holding portion formed of the polymeric material and shaped into a shell.

6. The humidity controlling material according to claim 1,
wherein the first particle has a core-shell structure including: a core containing the first humidity controlling liquid; and
the first holding portion formed of the polymeric material and shaped into a shell, and
the second holding portion included in the second particle is a water-absorbing polymer.

7. The humidity controlling material according to claim 1, further comprising
a fixed color particle configured to indicate a certain color.

8. The humidity controlling material according to claim 7,
wherein the fixed color particle includes: a humidity controlling liquid containing the hygroscopic substance; and
a holding portion holding the humidity controlling liquid in a form of a particle.

9. A humidity controlling apparatus, comprising:
the humidity controlling material according to claim 1; and
a housing portion housing the humidity controlling material,
wherein the housing portion is at least partially transparent to light.

10. The humidity controlling material according to claim 9,
wherein the housing portion includes: a first housing portion housing the first particle; and
a second housing portion housing the second particle.

11. The humidity controlling material according to claim 10, further comprising
a removing portion configured to remove moisture contained in the humidity controlling material.

12. The humidity controlling material according to claim 11,
wherein the first particle has a core-shell structure including: a core containing the first humidity controlling liquid; and the first holding portion formed of the polymeric material and shaped into a shell,
the second holding portion included in the second particle is a water-absorbing polymer, and
the removing portion is disposed closer to the first housing portion than to the second housing portion.
